(19) United States
(12) Patent Application Publication
(10) Pub. No.: US 2025/0223841 A1
(43) Pub. Date: Jul. 10, 2025

(54) CLUTCH RING STRUCTURE, TRANSMISSION AND CLUTCH MECHANISM, AND TRANSMISSION AND POSITIONING DEVICE

(71) Applicant: Wistron NeWeb Corporation, Hsinchu (TW)

(72) Inventor: You-Hao XU, Hsinchu (TW)

(21) Appl. No.: 19/007,734

(22) Filed: Jan. 2, 2025

(30) Foreign Application Priority Data
Jan. 4, 2024 (TW) 113100341

(51) Int. Cl. E05B 47/00; F16D 11/14; F16H 1/16; F16H 19/08; F16H 57/02; F16H 57/031; F16H 57/039

(52) U.S. Cl. CPC E05B 47/0012; F16D 11/14; F16H 1/16; F16H 19/08; F16H 57/031; F16H 57/039; E05B 2047/0017; E05B 2047/002; E05B 2047/0026; E05B 2047/0054; E05B 2047/0058; F16H 2057/02034

(57) ABSTRACT

A clutch ring structure includes a ring body including a first surface and a second surface opposite to each other along an axis, at least one clutch protrusion extending outward from the first surface along the axis, and at least one mounting member extending outward from the second surface along the axis. When a force parallel to the axis is exerted onto the at least one clutch protrusion, the at least one clutch protrusion is pushed by the force to allow the ring body to be deflected.

### RELATED APPLICATIONS

This application claims priority to Taiwan Application Serial Number 113100341, filed Jan. 4, 2024, which is herein incorporated by reference.

### BACKGROUND

### Technical Field

The present disclosure relates to a clutch ring structure, a clutch mechanism, and a positioning device. More particularly, the present disclosure relates to a clutch ring structure, a transmission and clutch mechanism, and a transmission and positioning device that are used for transmission.

### Description of Related Art

A conventional mechanical door lock may include a locking hole and a latch, and a key is used to open the lock by being inserted into the locking hole to rotate the latch. With the improvement of the technique, electronic locks adapting electric power are developed. With identification of the finger print, the card and the face, or the input of the password, a transmission gear and a transmission shaft in the electronic lock may be driven by a motor, thereby linking the latch to open the electronic lock.

The electronic lock generally includes a clutch structure on the transmission shaft so that a transmission gear and the transmission shaft are disengaged as the latch arrives at a predetermined position. In addition, since the door opening direction may be either a left opening or a right opening, the electronic locks with the right opening and the electronic locks with the left opening may include different mechanisms. Moreover, in order to increase the convenience of the user when buying the electronic lock, electronic locks adapting both the left opening and the right opening are developed, and a door opening direction may be automatically determined by the electronic locks. As a result, the electronic lock has different and complicated mechanisms, and an improvement is required.

### SUMMARY

According to one aspect of the present disclosure, a clutch ring structure includes a ring body including a first surface and a second surface opposite to each other along an axis, at least one clutch protrusion extending outward from the first surface along the axis, and at least one mounting member extending outward from the second surface along the axis. When a force parallel to the axis is exerted onto the at least one clutch protrusion, the at least one clutch protrusion is pushed by the force to allow the ring body to be deflected.

According to another aspect of the present disclosure, a transmission and clutch mechanism includes a clutch gear, a transmission shaft and a clutch ring structure. The clutch gear includes a gear surface. The transmission shaft is inserted through the clutch gear and includes a shaft portion and a ring flange. The ring flange extends radially and outward from the shaft portion and includes an annular surface facing toward the gear surface. The clutch ring structure sleeves on an outside of the transmission shaft and is sandwiched between the annular surface of the ring flange and the gear surface of the clutch gear. The clutch ring structure includes a ring body including a first surface and a second surface opposite to each other along an axis, at least one clutch protrusion extending outward from the first surface along the axis, and at least one mounting member extending outward from the second surface along the axis. The at least one mounting member is mounted at one of the annular surface and the gear surface. At least one transmission protrusion protrudes from another one of the annular surface and the gear surface and faces toward the at least one clutch protrusion. When the transmission shaft is rotated from an initial position to a first positioning position, the at least one clutch protrusion is pushed by the at least one transmission protrusion to allow the ring body to be deflected, and the at least one clutch protrusion moves from a first side of the at least one transmission protrusion to a second side of the at least one transmission protrusion.

According to still another aspect of the present disclosure, a transmission and positioning device includes a module case including an inner space, a motor disposed in the inner space, and a transmission and clutch mechanism disposed in the inner space. The transmission and clutch mechanism includes a clutch gear, a transmission shaft and a clutch ring structure. The clutch gear includes a gear surface. The transmission shaft is inserted through the clutch gear and includes a shaft portion and a ring flange. The ring flange extends radially and outward from the shaft portion and includes an annular surface facing toward the gear surface. The clutch ring structure sleeves on an outside of the transmission shaft and is sandwiched between the annular surface of the ring flange and the gear surface of the clutch gear. The clutch ring structure includes a ring body including a first surface and a second surface opposite to each other along an axis, at least one clutch protrusion extending outward from the first surface along the axis, and at least one mounting member extending outward from the second surface along the axis. The at least one mounting member is mounted at one of the annular surface and the gear surface. At least one transmission protrusion protrudes from another one of the annular surface and the gear surface and faces toward the at least one clutch protrusion. As the motor exerts a rotating force to drive the clutch gear, the rotating force rotates the transmission shaft via the at least one transmission protrusion and the at least one clutch protrusion, the transmission shaft is rotated from an initial position to a first positioning position, the at least one clutch protrusion is pushed by the at least one transmission protrusion to allow the ring body to be deflected, and the at least one clutch protrusion moves from a first side of the at least one transmission protrusion to a second side of the at least one transmission protrusion.

### BRIEF DESCRIPTION OF THE DRAWINGS

The disclosure can be more fully understood by reading the following detailed description of the embodiments, with reference made to the accompanying drawings as follows:

FIG. 1 shows a three-dimensional schematic view of a transmission and positioning device according to a first embodiment of the present disclosure.

FIG. 2 shows a partial exploded view of the transmission and positioning device of the first embodiment of FIG. 1.

FIG. 3 shows an exploded view of a transmission and positioning module of the transmission and positioning device of the first embodiment of FIG. 1.

FIG. 4 shows a schematic view of an inside of the transmission and positioning module and a battery assembly of the first embodiment of FIG. 3.

FIG. 5 shows an exploded view of a transmission and clutch mechanism of the transmission and positioning module of the first embodiment of FIG. 3.

FIG. 6 shows a top operating view of the transmission and clutch mechanism of the first embodiment of FIG. 5.

FIG. 7 shows a side operating view of the transmission and clutch mechanism of the first embodiment of FIG. 5.

FIG. 8 shows one schematic view of a circuit board and a signal washer of the transmission and positioning module of the first embodiment of FIG. 3.

FIG. 9 shows another schematic view of the circuit board and the signal washer of the transmission and positioning module of the first embodiment of FIG. 3.

FIG. 10A shows one part of a flow chart of judging a door opening direction used by the transmission and positioning device of the first embodiment of FIG. 1

FIG. 10B shows another part of the flow chart of judging the door opening direction used by the transmission and positioning device of the first embodiment of FIG. 1.

FIG. 11 shows an exploded view of a transmission and clutch mechanism according to a second embodiment of the present disclosure.

FIG. 12 shows an exploded view of a transmission and clutch mechanism according to a third embodiment of the present disclosure.

### DETAILED DESCRIPTION

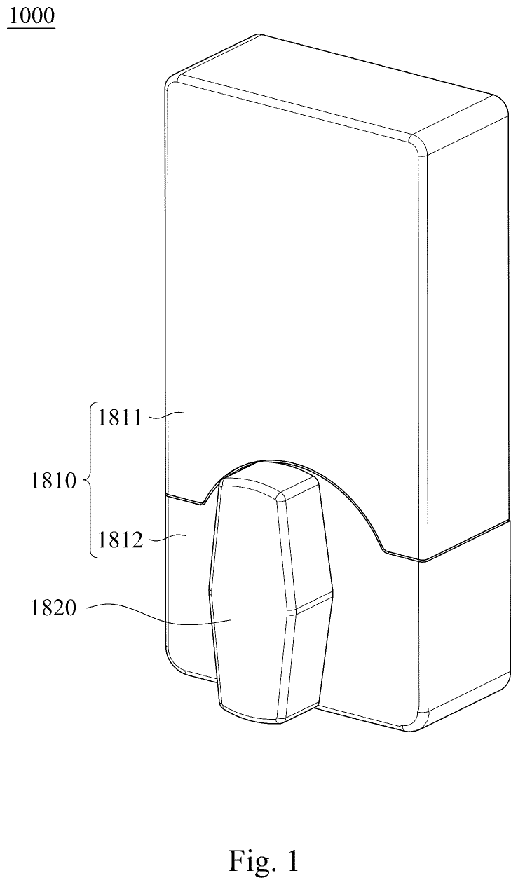

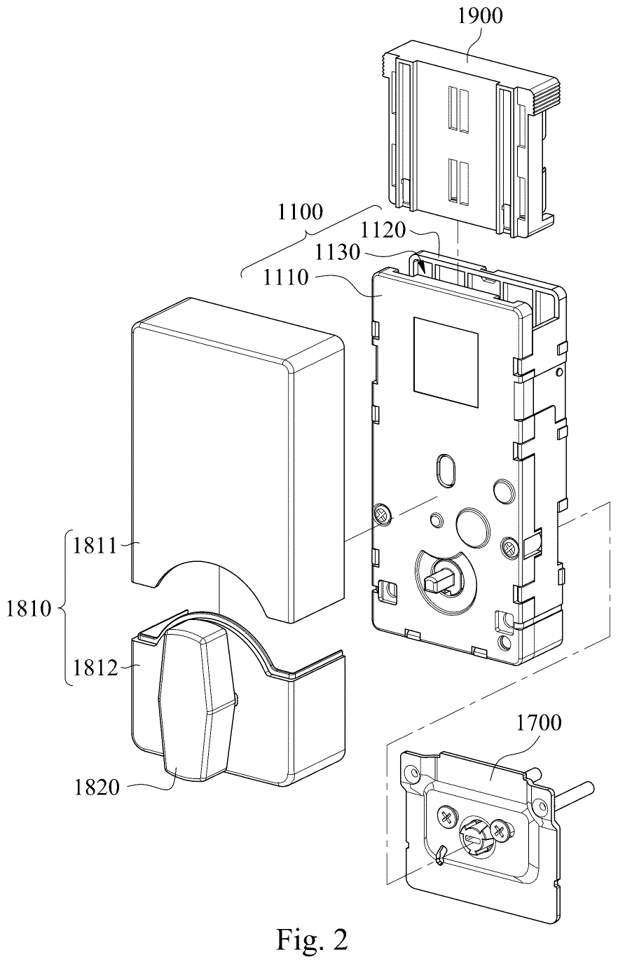

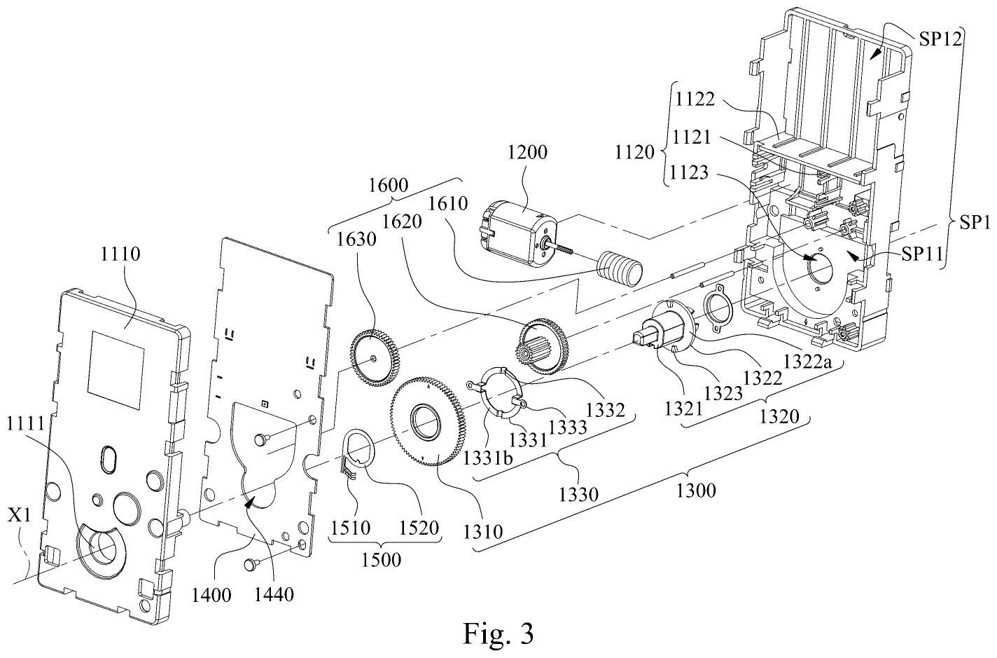

Please refer to FIGS. 1, 2 and 3, FIG. 1 shows a three-dimensional schematic view of a transmission and positioning device 1000 according to a first embodiment of the present disclosure, FIG. 2 shows a partial exploded view of the transmission and positioning device 1000 of the first embodiment of FIG. 1, and FIG. 3 shows an exploded view of a transmission and positioning module of the transmission and positioning device 1000 of the first embodiment of FIG. 1. The transmission and positioning device 1000 includes a module case 1100 including an inner space SP1, a motor 1200 disposed in the inner space SP1, and a transmission and clutch mechanism 1300 disposed in the inner space SP1.

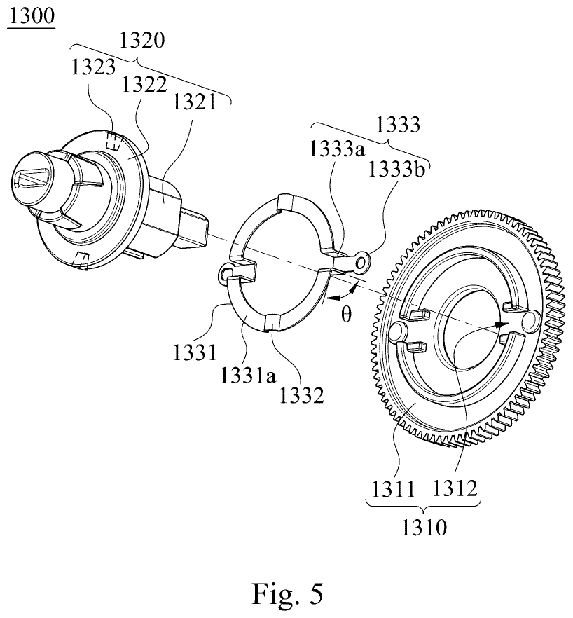

The transmission and clutch mechanism 1300 includes a clutch gear 1310, a transmission shaft 1320 and a clutch ring structure 1330. The clutch gear 1310 is driven by the motor 1200 and includes a gear surface 1311 (labeled in FIG. 5). The transmission shaft 1320 is inserted through the clutch gear 1310 and includes a shaft portion 1321 and a ring flange 1322. The ring flange 1322 extends radially and outward from the shaft portion 1321 and includes an annular surface 1322a facing toward the gear surface 1311. The clutch ring structure 1330 sleeves on an outside of the transmission shaft 1320 and is sandwiched between the annular surface 1322a of the ring flange 1322 and the gear surface 1311 of the clutch gear 1310. The clutch ring structure 1330 includes a ring body 1331 including a first surface 1331a (labeled in FIG. 5) and a second surface 1331b opposite to each other along an axis X1, at least one clutch protrusion 1332 extending outward from the first surface 1331a along the axis X1, and at least one mounting member 1333 extending outward from the second surface 1331b along the axis X1.

The at least one mounting member 1333 is mounted at one of the annular surface 1322a and the gear surface 1311. At least one transmission protrusion 1323 protrudes from another one of the annular surface 1322a and the gear surface 1311 and faces toward the at least one clutch protrusion 1332. As the motor 1200 exerts a rotating force to drive the clutch gear 1310, the rotating force rotates the transmission shaft 1320 via the at least one transmission protrusion 1323 and the at least one clutch protrusion 1332, the transmission shaft 1320 is rotated from an initial position to a first positioning position, the at least one clutch protrusion 1332 is pushed by the at least one transmission protrusion 1323 to allow the ring body 1331 to be deflected, and the at least one clutch protrusion 1332 moves from a first side of the at least one transmission protrusion 1323 to a second side of the at least one transmission protrusion 1323. In other embodiments, the ring body will be slightly deformed when deflected, but the present disclosure is not limited thereto.

Therefore, with the configuration that the clutch ring structure 1330 includes the clutch protrusion 1332 and the mounting member 1333 extending from the ring body 1331 toward different directions, it is convenient for the clutch ring structure 1330 to be assembled with other elements. Consequently, the mounting member 1333 may be designed to be mounted at the transmission shaft 1320 or the clutch gear 1310 when designing the transmission and clutch mechanism, thereby increasing the flexibility of the structure design and configuration. Details of the transmission and positioning device 1000 may be described hereinafter.

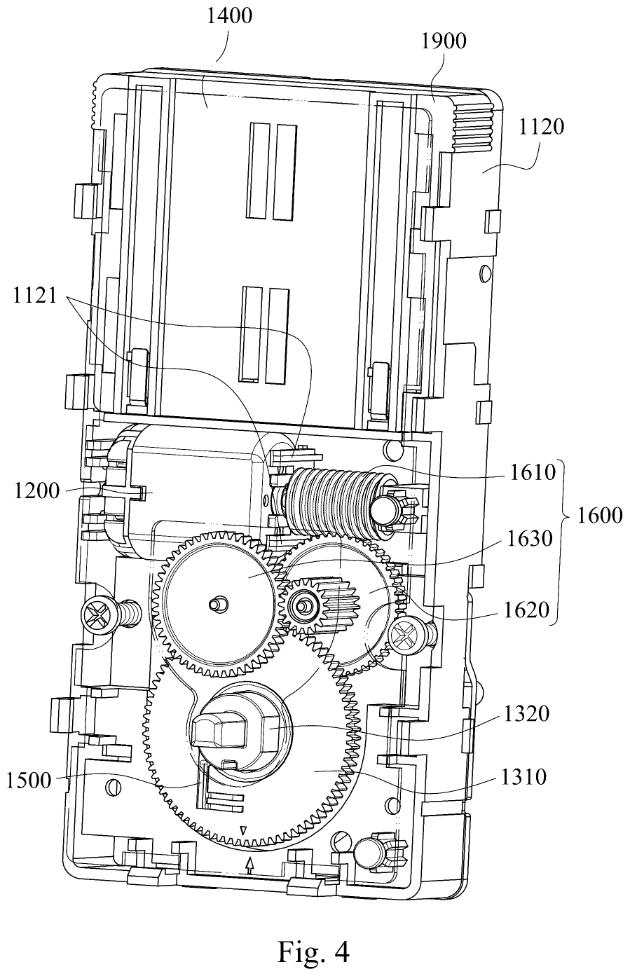

FIG. 4 shows a schematic view of an inside of the transmission and positioning module and a battery assembly 1900 of the first embodiment of FIG. 3. The module case 1100 is substantially rectangular and further includes a first housing 1110 and a second housing 1120. The inner space SP1 is formed by the second housing 1120 and the first housing 1110. The second housing 1120 includes a flexible clamping portion 1121 extending toward the first housing 1110 along the axis X1, and the flexible clamping portion 1121 is configured to restrict the motor 1200. Precisely, the first housing 1110 and the second housing 1120 may be assembled by engagement. A cap of the first housing 1110 may include a shaft bore 1111 for one end of the shaft portion 1321 to pass therethrough. Each of side walls of the second housing 1120 may have a longer length in the axis X1, and the second housing 1120 mainly provides the inner space SP1 for placing each element. The flexible clamping portion 1121 may integrally extend from a back board of the second housing 1120. A number of the flexible clamping portions 1121 may be two, and the two flexible clamping portions 1121 are located at one end of the motor 1200. Each of the flexible clamping portion 1121 may include a pushing block to push the motor 1200 toward the side wall of the second housing 1120. The flexible clamping portions 1121 may have elasticity and can be restored after being slightly deformed. Therefore, the motor 1200 can be fixed and can be held without screws. Moreover, the elasticity of the flexible clamping portions 1121 may be favorable for absorbing vibration, and no foam is required to reduce the vibration and noise. The back board of the second housing 1120 may further include a transmission hole 1123 for another end of the shaft portion 1321 to pass therethrough.

The transmission and positioning device 1000 may further include the battery assembly 1900, and the inner space SP1 is divided into a battery area SP12 and a transmission area SP11. The module case 1100 may further include an insertion opening 1130 communicated with the battery area SP12, and the battery assembly 1900 is inserted into the battery area SP12 from the insertion opening 1130. As shown in FIGS. 2 and 3, the second housing 1120 may further include a partition 1122 to separate the inner space SP1 into the battery area SP12 and the transmission area SP11, and the second housing 1120 does not include an upper side wall, thereby forming the insertion opening 1130 for inserting the battery assembly 1900. The battery assembly 1900 may include a battery bracket and batteries. After the battery assembly 1900 is inserted into the battery area SP12, a board of the battery bracket can close the insertion opening 1130. The transmission area SP11 may be configured to place the motor 1200 and the transmission and clutch mechanism 1300. The flexible clamping portion 1121 may protrude from the back board of the second housing 1120 to correspond to the transmission area SP11. More element fixing portions may protrude from or be formed at the back board of the second housing 1120, but the present disclosure is not limited thereto.

The transmission and positioning device 1000 may further include a driving force transmission mechanism 1600 including a worm 1610, a worm gear 1620 and a transmission gear 1630. The worm 1610 sleeves on an output shaft of the motor 1200, the worm gear 1620 is engaged with the worm 1610, the transmission gear 1630 is engaged with the worm gear 1620 so as to be driven by the worm gear 1620, and the clutch gear 1310 is engaged with and driven by the transmission gear 1630. Hence, the motor 1200 can drive the clutch gear 1310 via the driving force transmission mechanism 1600.

FIG. 5 shows an exploded view of the transmission and clutch mechanism 1300 of the transmission and positioning module of the first embodiment of FIG. 3, and it is noted that the view angle of FIG. 5 is opposite to the view angle of FIG. 4. Please refer to FIG. 5 with references of FIGS. 2 to 4, and in the first embodiment, the clutch ring structure 1330 is mounted at the clutch gear 1310. A number of the clutch protrusions 1332 is two, and a number of the mounting members 1333 is two. The ring body 1331 includes two curved segments. Each of the two mounting members 1333 includes two connecting arms 1333a and a restricting portion 1333b, the two connecting arms 1333a of each of the mounting members 1333 are connecting between the two curved segments, the restricting portion 1333b of each of the mounting members 1333 is connected between the two connecting arms 1333a, and an angle θ is contained between each of the connecting arms 1333a and the second surface 1331b.

To be more specific, the clutch ring structure 1330 may be made by stamping, and the ring body 1331, the two clutch protrusions 1332 and the two mounting members 1333 are formed integrally. The two clutch protrusions 1332 and the two mounting members 1333 are arranged alternatively and equidistantly. Precisely, the clutch ring structure 1330 may be a stamped metal or an injected plastic, each of the mounting members 1333 is connected between two curved segments, and therefore the clutch ring structure 1330 as a whole forms an annular structure. Each of the clutch protrusions 1332 may be formed at a middle of each of the curved segments so as to be arranged alternatively and equidistantly with the mounting members 1333. In other embodiments, a number of the clutch protrusions and the positions thereof may be relative to the rotating angle of the transmission shaft, and the present disclosure is not limited thereto. In the first embodiment, the angle θ contained between each of the connecting arms 1333a and the second surface 1331b is 90 degrees. In other words, the connecting arm 1333a substantially extends perpendicularly from the end of the curved segment along the axis X1. The restricting portion 1333b may be fixed at the gear surface 1311. Specifically, the restricting portion 1333b may include a riveting bore so as to be riveted or welded with the clutch gear 1310, but the present disclosure is not limited thereto.

The clutch gear 1310 may further include two grooves 1312 located at the gear surface 1311, and the two grooves 1312 respectively correspond to the two restricting portions 1333b for mounting the restricting portions 1333b.

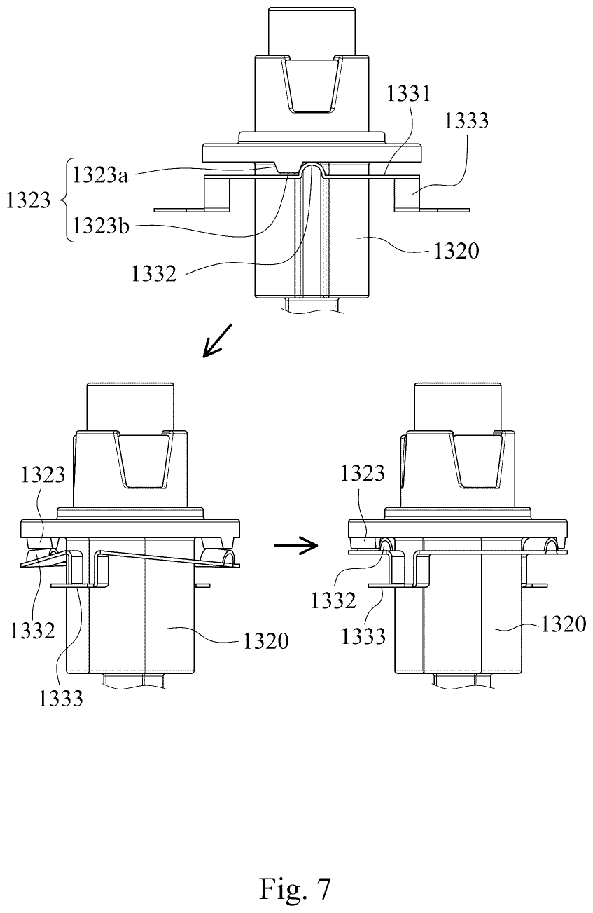

A number of the transmission protrusions 1323 may be two and are disposed at the annular surface 1322a with intervals. Each of the transmission protrusions 1323 may include an abutting plane 1323b (labeled in FIG. 7) and two slope surfaces 1323a (labeled in FIG. 7). The two slope surfaces 1323a of each of the transmission protrusions 1323 are respectively connected to two sides of the abutting plane 1323b, and therefore a cross section of the transmission protrusion 1323 is trapezoidal. Moreover, the shaft portion 1321 of the transmission shaft 1320 is divided into a front shaft segment and a rear shaft segment by the ring flange 1322. The front shaft segment sequentially passes through the clutch ring structure 1330 and a gear bore of the clutch gear 1310, and thus the clutch ring structure 1330 may be sandwiched between the ring flange 1322 and the clutch gear 1310 to allow the clutch protrusion 1332 to correspond to the transmission protrusion 1323.

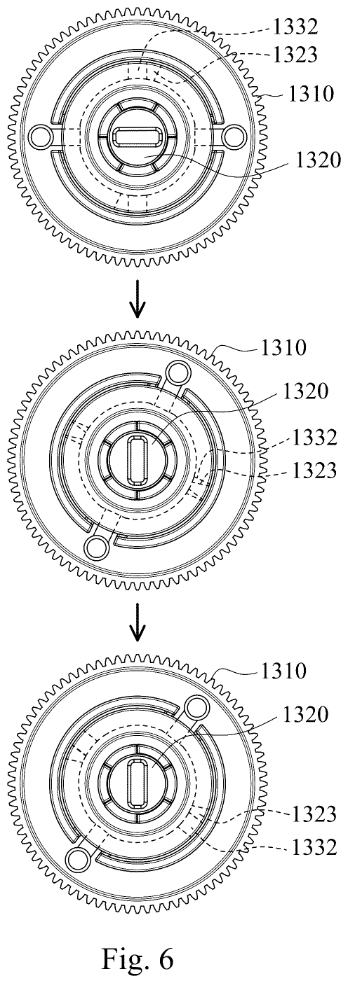

FIG. 6 shows a top operating view of the transmission and clutch mechanism 1300 of the first embodiment of FIG. 5, FIG. 7 shows a side operating view of the transmission and clutch mechanism 1300 of the first embodiment of FIG. 5, and it is noted that the top view of FIG. 6 is a result obtained by viewing from left to right in FIG. 5. Please refer to FIGS. 6 and 7 with references of FIGS. 2 to 5, the rear shaft segment of the shaft portion 1321 can be used to connect to a latch, and the latch can be protruded or retracted via forward rotation or reverse rotation of the shaft portion 1321. Hence, when the motor 1200 is rotated, the rotating force may be exerted on the clutch gear 1310, and the rotating force may rotate the transmission shaft 1320 via the transmission protrusion 1323 and the clutch protrusion 1332. Precisely, at beginning, the clutch protrusion 1332 may be located at the first side of the transmission protrusion 1323. As the clutch gear 1310 is rotated, the clutch protrusion 1332 pushes the transmission protrusion 1323 to rotate the transmission shaft 1320, thereby allowing the latch to arrive at a specific position. At this time, the transmission shaft 1320 cannot be rotate any more while the clutch gear 1310 keeps rotating. Since the restricting portion 1333b is fixed and cannot be moved, the clutch protrusion 1332 is pushed to allow the ring body 1331 to be deflected. The connecting arm 1333a may also be moved to be deformed or deflected. As a result, the clutch protrusion 1332 may move from the first side of the transmission protrusion 1323 to the second side of the transmission protrusion 1323. As such, damage of the motor 1200 is avoided, and the transmission shaft 1320 may also be returned when the motor 1200 rotates reversely. It is noted that, if at this moment the latch is protruded and is in a lock status, then when a user opens the door by inserting a key into a locking hole and reversely rotates the transmission shaft 1320, the clutch protrusion 1332 will not prohibit the door opening owing to that the clutch protrusion 1332 has moved to the second side of the transmission protrusion 1323. In addition, FIGS. 6 and 7 showed an example of a first direction opening, e.g., the left opening, but the present disclosure is not limited thereto.

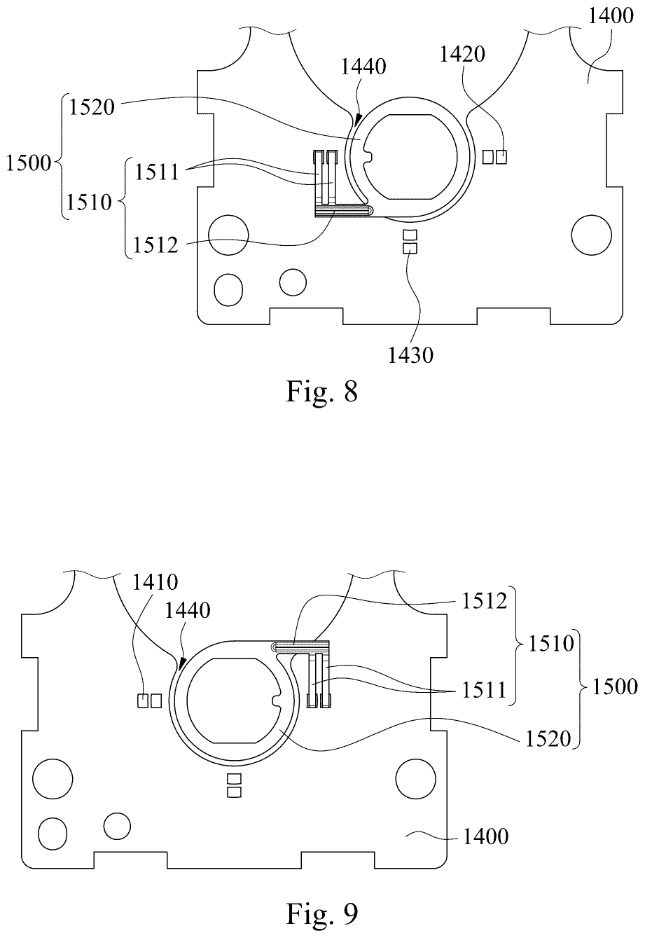

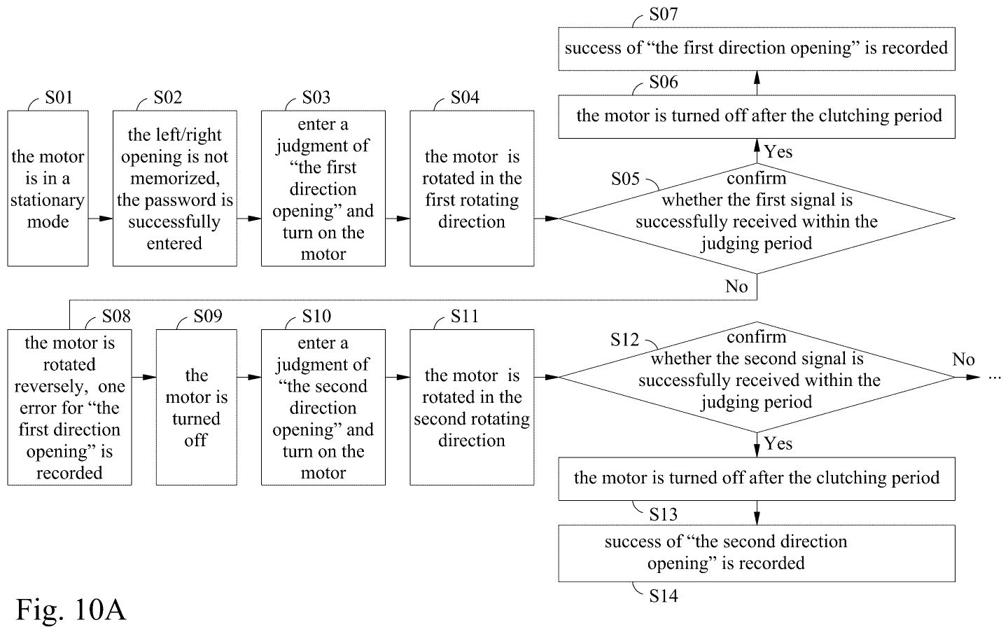

FIG. 8 shows one schematic view of a circuit board 1400 and a signal washer 1500 of the transmission and positioning module of the first embodiment of FIG. 3. FIG. 9 shows another schematic view of the circuit board 1400 and the signal washer 1500 of the transmission and positioning module of the first embodiment of FIG. 3. The transmission and positioning device 1000 may further include the circuit board 1400 and the signal washer 1500. The circuit board 1400 is disposed at a first side of the clutch gear 1310 and includes a through hole 1440, a first metal contacting portion 1410 and a second metal contacting portion 1420, and the first side is far away from the clutch ring structure 1330. The through hole 1440 is for the transmission shaft 3320 to pass therethrough. The first metal contacting portion 1410 and the second metal contacting portion 1420 surround the through hole 1440. The signal washer 1500 sleeves on the transmission shaft 1320 and is located between the circuit board 1400 and the clutch gear 1310, and the signal washer 1500 includes a signal elastic arm 1510. The signal elastic arm 1510 contacts the first metal contacting portion 1410 when the transmission shaft 1320 is located at the first positioning position, and the signal elastic arm 1510 contacts the second metal contacting portion 1420 when the transmission shaft 1320 is located at a second positioning position.

To be more specific, as shown in FIGS. 3 and 4, the circuit board 1400 is near the first housing 1110, and the through hole 1440 corresponds to the shaft bore 1111. As shown in FIGS. 8 and 9, the circuit board 1400 may further include a third metal contacting portion 1430. The third metal contacting portion 1430, the first metal contacting portion 1410 and the second metal contacting portion 1420 surround the through hole 1440, an angle difference between the third metal contacting portion 1430 and the first metal contacting portion 1410 is 90 degrees, and an angle difference between the third metal contacting portion 1430 and the second metal contacting portion 1420 is also 90 degrees. Each of the first metal contacting portion 1410, the second metal contacting portion 1420 and the third metal contacting portion 1430 includes two bare copper areas which may be formed by partially exposing a copper portion of the circuit board 1400 so as to achieve manufacturing convenience, but the present disclosure is not limited thereto.

The signal washer 1500 may include a sleeve 1520 for sleeving the shaft portion 1321 of the transmission shaft 1320 and being integrally connected to the signal elastic arm 1510. The signal elastic arm 1510 includes two arm portions 1511 and one connecting portion 1512. One end of the connecting portion 1512 is connected to the sleeve 1520 and the two arm portions 1511 are connected to the other end of the connecting portion 1512 perpendicularly. Therefore, as the transmission shaft 1320 is rotated, the signal elastic arm 1510 is allowed to contact the first metal contacting portion 1410, the second metal contacting portion 1420 or the third metal contacting portion 1430, and thus different signals may be sent to a controller of the circuit board 1400 for confirming whether the transmission shaft 1320 is located at the first positioning position, the second positioning position or the initial position. It is noted that, as a number of the bare copper areas is two and a number of the arm portions 1511 is two, it is certain that the arm portions 1511 can correspond to the first metal contacting portion 1410, the second metal contacting portion 1420 or the third metal contacting portion 1430 after rotation to prevent detecting errors. In addition, in other embodiments, the two arm portions may not be connected to the connecting portion perpendicularly, the two arm portions can be connected from the connecting portion toward the circuit board for a three-dimensional extension, that is, the arm portions and the connecting portion are not coplanar, thereby achieving a function of swinging up and down.

Therefore, with the configuration that the circuit board 1400 includes the first metal contacting portion 1410, the second metal contacting portion 1420, the third metal contacting portion 1430 and the signal washer 1500, a conventional micro switch is not required. Consequently, setting a conventional bump for triggering the micro switch as the conventional clutch ring structure is not required. As a result, the clutch ring structure may be simplified, and the signal washer 1500 also has the function of a conventional washer.

During assembling, the elements may be positioned in the second housing 1120 first, and then the first housing 1110 is assembled. The transmission and positioning device 1000 may further include a cover 1810 and a knob 1820. The cover 1810 covers on the module case 1100, especially covering from the first housing 1110 toward the second housing 1120, and the knob 1820 is connected to the transmission shaft 1320 and includes an operated portion exposing from the cover 1810. The cover 1810 may include an upper cover 1911, and a lower cover 1812 connected to each other. The lower cover 1812 may include a hole, and the knob 1820 is disposed at the lower cover 1812 and corresponds to the hole. The transmission shaft 1320 may extend from the shaft bore 1111 of the first housing 1110 to be inserted into the knob 1820 via the hole so as to be rotated by the knob 1820. The transmission and positioning device may further include a mounting board 1700 disposed at the back board of the second housing 1120, for mounting the transmission and positioning device 1000 at a predetermined position, e.g., a door.

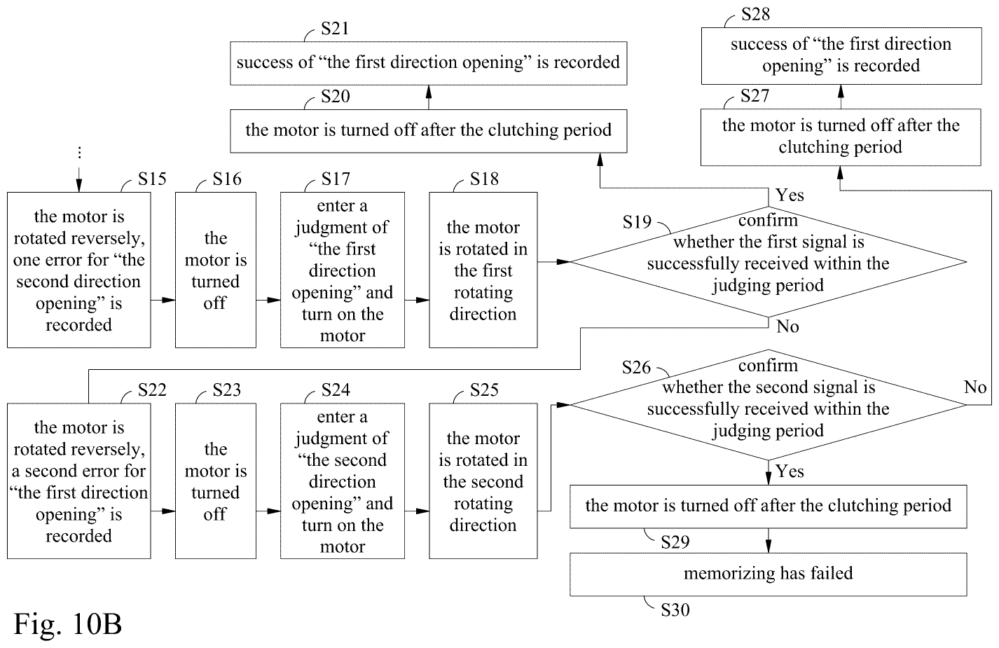

FIG. 10A shows one part of a flow chart of judging a door opening direction used by the transmission and positioning device 1000 of the first embodiment of FIG. 1. FIG. 10B shows another part of the flow chart of judging the door opening direction used by the transmission and positioning device 1000 of the first embodiment of FIG. 1. By connecting a latch to the transmission shaft 1320, the transmission and positioning device 1000 may be served as an electronic lock. The latch may be disposed at different sides of the transmission and positioning device 1000 according to different door opening direction. For example, if standing on the outside of the door and looking inside, a left opening indicates that the door is rotated from a right side to a left side, the latch is located in a right side of FIG. 6 (a left side in FIG. 8), and the latch may extend outward to the right side in FIG. 6 and retract toward a left side in FIG. 6 (a right side in FIG. 8). Similarly, a right opening indicates that the door is rotated from the left side to the right side, the latch is located in the left side of FIG. 6, and the latch may extend outward to the left side in FIG. 6 and retract toward the right side in FIG. 6. Therefore, a rotating direction of the motor 1200 may be matched with the door opening direction. Accordingly, a door opening direction automatic judging method may be used to automatically confirm the door opening direction.

When executing the door opening direction automatic judging method, the controller disposed at the circuit board 1400 may send a first direction opening judging command, and the motor 1200 is turned on to rotate the clutch gear 1310 in a first rotating direction. If the controller receives a first signal within a judging period, the first rotating direction is defined as the door opening direction and the motor 1200 is turned off. If the controller does not receive the first signal within the judging period, the controller sends a second direction opening judging command, and the motor 1200 is turned on to rotate the clutch gear 1310 in a second rotating direction. If the controller receives a second signal within the judging period, the second rotating direction is defined as the door opening direction and the motor 1200 is turned off. The first signal is generated when the signal elastic arm 1510 contacts the first metal contacting portion 1410, the second signal is generated when the signal elastic arm 1510 contacts the second metal contacting portion, and the signal elastic arm 1510 contacts the third metal contacting portion 1430 when the transmission shaft 1320 is located at the initial position.

If the controller does not receive the first signal within the judging period, the controller rotates the motor 1200 in the second rotating direction first, and then the controller sends the second direction opening judging command. In addition, the controller starts to calculate a clutching period after receiving the first signal or the second signal, and then the motor 1200 is turned off. In the first embodiment, the required time period for the motor 1200 to rotate the signal washer 1500 90 degrees is known. Consequently, when conducting the judgment, since the transmission shaft 1320 may not be in the initial position, and the time period required for the transmission shaft 1320 to rotate to the first positioning position or the second positioning position may exceed the time period that the signal washer 1500 rotates 90 degrees, it is better to set the required time period of the signal washer 1500 rotating 180 degrees to be the judging period. In addition, if the motor 1200 is immediately turned off when the transmission shaft 1320 arrives at the predetermined position, the clutch protrusion 1332 may not move from the first side of the transmission protrusion 1323 to the second side thereof or move from the second side of the transmission protrusion 1323 to the first side thereof, and the transmission shaft 1320 cannot return back when reversely rotating the motor 1200, which may also affect the user to open the lock manually. Therefore, the motor 1200 is required to be turned off later, especially being turned off after the clutching period which is a time period that the clutch ring structure conducts one clutch.

To be more specific, as shown in FIG. 10A, in Step S01, the motor 1200 is in a stationary mode, that is, the motor 1200 is not turned on and does not rotate. Next, Step S02 is executed, where, in a status that the left/right opening is not memorized, the password is successfully entered. The controller may send the first direction opening judging command, that is, Step S03 is executed to enter a judgment of “the first direction opening” and turn on the motor 1200. In Step S04, the motor 1200 is rotated in the first rotating direction, and Step S05 is executed to confirm whether the first signal is successfully received within the judging period. If it is “the first direction opening”, the motor 1200 can successfully drive the transmission shaft 1320 to move the signal washer 1500, so that the signal elastic arm 1510 contacts the first metal contacting portion 1410, thereby generating the first signal. On the contrary, if the first signal is not generated, it may not be “the first direction opening”, so that the signal elastic arm 1510 does not contact the first metal contacting portion 1410 to generate the first signal. Hence, if in Step S05 the first signal is successfully received within the judging period, the motor 1200 is turned off after the clutching period in Step S06, and then Step S07 is performed, where success of “the first direction opening” is recorded by the controller, and the judgment of the door opening direction is finished. In other words, receiving the first signal indicates that the latch can successfully extend in the direction of the left side of FIG. 8 to lock the door, so after unlocking, the door can be pushed opened using the way of “the first direction opening”.

If in Step S05 the first signal is not successfully received within the judging period, Step S08 is executed, where the motor 1200 is rotated reversely by the controller, and one error for “the first direction opening” is recorded by the controller. Then, in Step S09, the motor 1200 is turned off. At this time, it can pause for 0.5 second to 1 second, and then turn on the motor 1200 again. Next, the controller may send the second direction opening judging command, that is, execute Step S10 to enter a judgment of “the second direction opening” and turn on the motor 1200. Step S11 is then performed, where the motor 1200 is rotated in the second rotating direction. Step S12 is executed to confirm whether the second signal is successfully received within the judging period. If it is “the second direction opening”, the motor 1200 can successfully drive the transmission shaft 1320 to move the signal washer 1500, so that the signal elastic arm 1510 contacts the second metal contacting portion 1420, thereby generating the second signal. On the contrary, if the second signal is not generated, it may not be “the second direction opening”, so that the signal elastic arm 1510 does not contact the second metal contacting portion 1420 to generate the second signal. Hence, if in Step S12 the second signal is successfully received within the judging period, the motor 1200 is turned off after the clutching period in Step S13, and then Step S14 is executed, where success of “the second direction opening” is recorded by the controller, and the judgment of the door opening direction is finished. It is noted that, receiving the second signal indicates the latch can successfully extend in the direction of the right side of FIG. 8 to lock the door, so after unlocking, the door can be pushed opened using the way of “the second direction opening” method.

As shown in FIGS. 10A and 10B, if in Step S12 the second signal is not successfully received within the judging period, Step S15 is executed, where the motor 1200 is rotated reversely by the controller, and one error for “the second direction opening” is recorded by the controller. Then, Step S16 is executed, where the motor 1200 is turned off. It is noted that, in Step S08 and Step S09, the motor 1200 being rotated reversely refers to that the motor 1200 is rotated in a direction opposite to the original direction, and no specific direction is indicated.

Afterwards, Steps S17, S18, S19 are performed, the contents thereof are identical to Steps S03, S04, S05, and whether to execute Steps S20, S21 or execute Step S22 is decided based on the judgment result of Step S19. Steps S20, S21 are identical to Steps S06, S07. In Step S22, the motor 1200 is rotated reversely by the controller, and a second error for “the first direction opening” is recorded by the controller. Then, the motor 1200 is turned off in Step S23. Subsequently, Steps S24, S25, S26 are performed, the contents thereof are identical to Steps S10, S11, S12, and whether to execute Steps S27, S28 or execute Steps S29, S30 is decided based on the judgment result of Step S26. Steps S27, S28 are identical to Steps S13, S14. In Step S29, the motor 1200 is turned off after the clutch period. Finally, Step S30 is performed, where memorizing (door opening direction) by the controller has failed, and the judgment of the door opening direction is finished. In other words, if the judgments of “the first opening direction” and “the second door opening direction” have both failed 2 times (two errors), it could be that the transmission and positioning device 1000 itself has a malfunction, and further conformation is required.

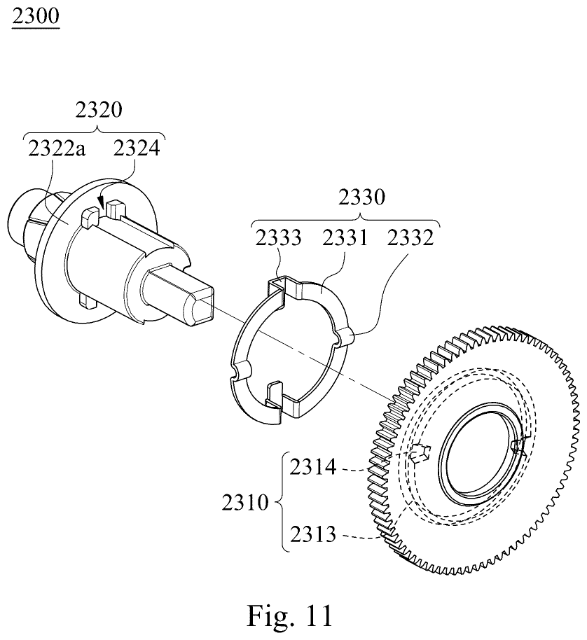

FIG. 11 shows an exploded view of a transmission and clutch mechanism 2300 according to a second embodiment of the present disclosure. The clutch mechanism 2300 is similar to the clutch mechanism 1300 of the first embodiment, but the clutch mechanism 2300 is mounted at the transmission shaft 2320. Precisely, a clutch gear 2310 may further include a restricting wall 2313 protruding from the gear surface and a chamber is formed by the restricting wall and a central area of the gear surface. The chamber can accommodate a ring body 2331. Two transmission protrusions 2314 may be disposed with an interval at the central area of the gear surface, and each of the transmission protrusions 2314 is connected to an inner edge of the restricting wall 2313 for coordinating with each of two clutch protrusions 2332. A transmission shaft 2320 may include two positioning grooves 2324 disposed at the annular surface 2322a with an interval, and each of two mounting members 2333 may be mounted at each of the positioning grooves 2324, for example, by welding or riveting. Hence, the clutch gear 2310 may rotate the clutch ringing structure 2330 to rotate the transmission shaft 2320 via the transmission protrusions 2314.

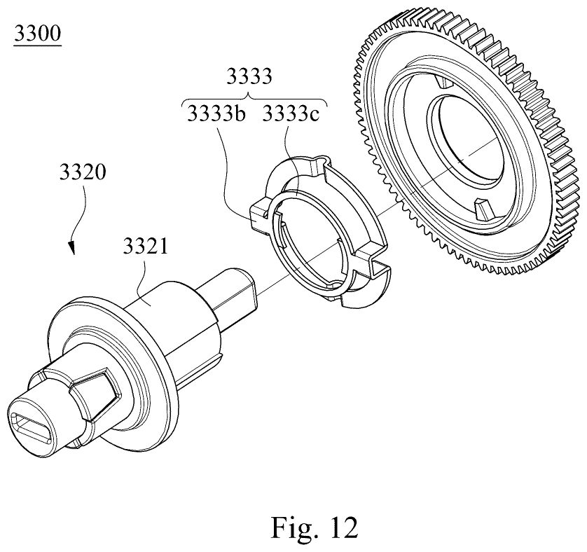

FIG. 12 shows an exploded view of a transmission and clutch mechanism 3300 according to a third embodiment of the present disclosure. The clutch mechanism 3300 is similar to the clutch mechanism 2300 of the second embodiment, but each of two mounting members 3333 of a clutch ring structure may further include a positioning ring 3333c connected to two restricting portions 3333b. The positioning ring 3333c may sleeve on a shaft portion 3321 of a transmission shaft 3320, and therefore the clutch ring structure may rotate with the transmission shaft 3320.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A clutch ring structure, comprising:
a ring body comprising a first surface and a second surface opposite to each other along an axis;
at least one clutch protrusion extending outward from the first surface along the axis; and
at least one mounting member extending outward from the second surface along the axis;
wherein, when a force parallel to the axis is exerted onto the at least one clutch protrusion, the at least one clutch protrusion is pushed by the force to allow the ring body to be deflected.

2. The clutch ring structure of claim 1, wherein a number of the at least one clutch protrusion is two, a number of the at least one mounting member is two, the ring body comprises two curved segments, each of the two mounting members comprises two connecting arms and a restricting portion, the two connecting arms of each of the mounting members are connecting between the two curved segments, the restricting portion of each of the mounting members is connected between the two connecting arms, and an angle is contained between each of the connecting arms and the second surface.

3. The clutch ring structure of claim 2, wherein, when the force parallel to the axis is exerted onto the clutch protrusions, the restricting portion of each of the mounting members is not moved, but the two connecting arms of each of the mounting members are deformed or deflected.

4. The clutch ring structure of claim 1, wherein the at least one clutch protrusion and the at least one mounting member are arranged alternatively and equidistantly.

5. A transmission and clutch mechanism, comprising:
a clutch gear comprising a gear surface;
a transmission shaft inserted through the clutch gear and comprising:
a shaft portion; and
a ring flange extending radially and outward from the shaft portion and comprising an annular surface facing toward the gear surface; and
a clutch ring structure sleeving on an outside of the transmission shaft and being sandwiched between the annular surface of the ring flange and the gear surface of the clutch gear, the clutch ring structure comprising:
a ring body comprising a first surface and a second surface opposite to each other along an axis;
at least one clutch protrusion extending outward from the first surface along the axis; and
at least one mounting member extending outward from the second surface along the axis;
wherein the at least one mounting member is mounted at one of the annular surface and the gear surface, at least one transmission protrusion protrudes from another one of the annular surface and the gear surface and faces toward the at least one clutch protrusion, when the transmission shaft is rotated from an initial position to a first positioning position, the at least one clutch protrusion is pushed by the at least one transmission protrusion to allow the ring body to be deflected, and the at least one clutch protrusion moves from a first side of the at least one transmission protrusion to a second side of the at least one transmission protrusion.

6. The transmission and clutch mechanism of claim 5, wherein a number of the at least one clutch protrusion is two, a number of the at least one mounting member is two, the ring body comprises two curved segments, each of the two mounting members comprises two connecting arms and a restricting portion, the two connecting arms of each of the mounting members are connecting between the two curved segments, the restricting portion of each of the mounting members is connected between the two connecting arms, and an angle is contained between each of the connecting arms and the second surface.

7. The transmission and clutch mechanism of claim 6, wherein a number of the at least one transmission protrusion is two, the transmission protrusions are disposed at the annular surface with intervals, and the restricting portion of each of the mounting members is mounted at the gear surface.

8. The transmission and clutch mechanism of claim 6, wherein a number of the at least one transmission protrusion is two, the transmission protrusions are disposed at the gear surface of the clutch gear with intervals, the transmission shaft further comprises two positioning grooves disposed at the annular surface with intervals, and each of the mounting members is mounted at each of the positioning grooves.

9. The transmission and clutch mechanism of claim 5, wherein the at least one transmission protrusion comprises an abutting plane and two slope surfaces, and the two slope surfaces of the at least one transmission protrusion are respectively connected to two sides of the abutting plane.

10. A transmission and positioning device, comprising:
a module case comprising an inner space;
a motor disposed in the inner space; and
a transmission and clutch mechanism disposed in the inner space and comprises:
a clutch gear comprising a gear surface;
a transmission shaft inserted through the clutch gear and comprising:
a shaft portion; and
a ring flange extending radially and outward from the shaft portion and comprising an annular surface facing toward the gear surface; and
a clutch ring structure sleeving on an outside of the transmission shaft and being sandwiched between the annular surface of the ring flange and the gear surface of the clutch gear, the clutch ring structure comprising:
a ring body comprising a first surface and a second surface opposite to each other along an axis;
at least one clutch protrusion extending outward from the first surface along the axis; and
at least one mounting member extending outward from the second surface along the axis;
wherein the at least one mounting member is mounted at one of the annular surface and the gear surface, at least one transmission protrusion protrudes from another one of the annular surface and the gear surface and faces toward the at least one clutch protrusion, as the motor exerts a rotating force to drive the clutch gear, the rotating force rotates the transmission shaft via the at least one transmission protrusion and the at least one clutch protrusion, the transmission shaft is rotated from an initial position to a first positioning position, the at least one clutch protrusion is pushed by the at least one transmission protrusion to allow the ring body to be deflected, and the at least one clutch protrusion moves from a first side of the at least one transmission protrusion to a second side of the at least one transmission protrusion.

11. The transmission and positioning device of claim 10, further comprising a circuit board and a signal washer, wherein the circuit board is disposed at a first side of the clutch gear and comprises a through hole, a first metal contacting portion and a second metal contacting portion, the first side is far away from the clutch ring structure, the through hole is for the transmission shaft to pass therethrough, the first metal contacting portion and the second metal contacting portion surround the through hole, the signal washer sleeves on the transmission shaft and is located between the circuit board and the clutch gear, the signal washer comprises a signal elastic arm, the signal elastic arm contacts the first metal contacting portion when the transmission shaft is located at the first positioning position, and the signal elastic arm contacts the second metal contacting portion when the transmission shaft is located at a second positioning position.

12. The transmission and positioning device of claim 11, further comprising a latch connected to the transmission shaft such that the transmission and positioning device is served as an electronic lock, wherein, when a door opening direction automatic judging method is executed, a controller disposed at the circuit board sends a first direction opening judging command, the motor is turned on to rotate the clutch gear in a first rotating direction, if the controller receives a first signal within a judging period, the first rotating direction is defined as a door opening direction and the motor is turned off, if the controller does not receive the first signal within the judging period, the controller sends a second direction opening judging command, the motor is turned on to rotate the clutch gear in a second rotating direction, if the controller receives a second signal within the judging period, the second rotating direction is defined as the door opening direction and the motor is turned off, the first signal is generated when the signal elastic arm contacts the first metal contacting portion, and the second signal is generated when the signal elastic arm contacts the second metal contacting portion.

13. The transmission and positioning device of claim 12, wherein the controller starts to calculate a clutching period after receiving the first signal or the second signal, and then the motor is turned off.

14. The transmission and positioning device of claim 12, wherein if the controller does not receive the first signal within the judging period, the controller rotates the motor in the second rotating direction first, and then the controller sends the second direction opening judging command.

15. The transmission and positioning device of claim 11, wherein the circuit board further comprises a third metal contacting portion, and the signal elastic arm contacts the third metal contacting portion when the transmission shaft is located at the initial position.

16. The transmission and positioning device of claim 15, wherein each of the first metal contacting portion, the second metal contacting portion and the third metal contacting portion comprises two bare copper areas, and the signal elastic arm comprises two arm portions.

17. The transmission and positioning device of claim 10, wherein the module case further comprises:
a first housing; and
a second housing, wherein the inner space is formed by the second housing and the first housing, the second housing comprises a flexible clamping portion extending toward the first housing along the axis, and the flexible clamping portion is configured to restrict the motor.

18. The transmission and positioning device of claim 10, further comprising a battery assembly, wherein the inner space is divided into a battery area and a transmission area, the module case further comprises an insertion opening communicated with the battery area, and the battery assembly is inserted into the battery area from the inserting opening.

19. The transmission and positioning device of claim 10, further comprising:
a cover covering on the module case; and
a knob connected to the transmission shaft and comprising an operated portion exposing from the knob.

20. The transmission and positioning device of claim 10, wherein a number of the at least one clutch protrusion is two, a number of the at least one mounting member is two, the ring body comprises two curved segments, each of the two mounting members comprises two connecting arms and a restricting portion, the two connecting arms of each of the mounting members are connecting between the two curved segments, the restricting portion of each of the mounting members is connected between the two connecting arms, and an angle is contained between each of the connecting arms and the second surface.
